(19) United States
(12) Patent Application Publication
(10) Pub. No.: US 2013/0120570 A1
(43) Pub. Date: May 16, 2013

(54) METHOD, APPARATUS AND SYSTEM FOR PRIORITISING CONTENT FOR DISTRIBUTION

(71) Applicant: Sony Corporation, Tokyo (JP)

(72) Inventors: Russell STANLEY, Basingstoke (GB); Jian-Rong CHEN, Shinfield (GB); Gareth LEWIS, Sherfield-on-London (GB); Alan TURNER, Basingstoke (GB)

(73) Assignee: Sony Corporation, Tokyo (JP)

(21) Appl. No.: 13/671,198

(22) Filed: Nov. 7, 2012

(30) Foreign Application Priority Data
Nov. 10, 2011 (GB) 1119404.0

(51) Int. Cl. H04N 7/18

(52) U.S. Cl. 348/143; 348/E07.085

(57) ABSTRACT

A method of prioritising content for distribution from a camera to a server over an Internet Protocol (IP) network, the method comprising: storing a plurality of audio and/or video data packages to be distributed to the server over the IP network; obtaining information indicating the priority at which each audio and/or video package is to be distributed over the IP network, the priority being determined in accordance with the content of the audio and/or video package; and sending each audio and/or video data package over the IP network, the order in which each audio and/or video data package is sent being determined in accordance with the indicated priority.

### CROSS REFERENCE TO RELATED APPLICATION

The present application claims the benefit of the earlier filing date of GB1119404.0 filed in the UK Patent Office on 10 Nov. 2011, the entire content of which application is incorporated herein by reference.

### BACKGROUND

1. Field of Disclosure

The present invention relates to a method and apparatus for prioritising content.

2. Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Given the ever increasing demand for 24 hour news, and the desire of people to be kept informed of current affairs, the acceptable length of time between scene capture and broadcast is reducing. Traditionally, for “breaking news” (where a live feed is required), outside broadcast vans are required. These have a dedicated satellite link between the van and the editing suite located in a studio.

There are two problems with relying on outside broadcast vans to cover news stories. Firstly, as the vans have a number of staff allocated to them they are expensive to maintain. Additionally, the vans arrive on the scene of a spontaneous breaking news event a great deal of time after the event has occurred.

In order to address this, it is possible to purchase a wireless adapter that attaches to a camera which compresses the captured audio/video data and transmits this over a 3G or even a 4G wireless telecommunication system. This enables the live stream captured by the camera to be sent to the studio.

Whilst this does enable a single video journalist to arrive at the scene of a breaking news event and to provide a live video stream, there are a number of disadvantages with this solution.

Firstly, in order to enable a live stream to be sent over a wireless telecommunication system, the video stream must be sent over a channel having a data rate of approximately 2 Mb/s. As a broadcast quality video stream has a data rate of between 25 Mb/s to 50 Mb/s, a large amount of compression of the live video stream must take place. This reduces the quality of the captured stream which is undesirable.

Secondly, in reality many video journalists also attend the scene of a breaking news event. Therefore, the data rate allocated to each video journalist for a live video stream is typically less than 2 Mb/s. In instances, the amount of bandwidth provided to each journalist is so low that the live video stream is lost.

This solution therefore needs improvement. It is an aim of embodiments of the present invention to address these problems.

### SUMMARY

It is to be understood that both the foregoing general description of the invention and the following detailed description are exemplary, but are not restrictive, of the invention.

According to one aspect of the present invention, there is provided a method of prioritising content for distribution from a camera to a server over an Internet Protocol (IP) network, the method comprising: storing a plurality of audio and/or video data packages to be distributed to the server over the IP network; obtaining information indicating the priority at which each audio and/or video package is to be distributed over the IP network, the priority being determined in accordance with the content of the audio and/or video package; and sending each audio and/or video data package over the IP network, the order in which each audio and/or video data package is sent being determined in accordance with the indicated priority.

This is advantageous because the most important (or highest priority) pieces of content are sent over the IP network first. This ensures that the latency between capturing the more important pieces of footage and broadcasting this footage is reduced. Also, by prioritising the order in which the footage is transferred improves the efficiency in which bandwidth is used.

The method may further generate metadata associated with the content of each of the audio and/or video data packages, and sending the generated metadata over the IP network to the server, wherein the priority information is generated at the server in accordance with the metadata and is obtained over the IP network.

The metadata may comprise a low resolution version of the audio and/or video data package.

The priority information may be provided by the server in response to a poll from the camera.

The method may further comprise obtaining an edit decision list defining an edited audio and/or video package to be generated from the stored plurality of audio and/or video packages, obtaining information indicating the priority at which the edited audio and/or video package is to be sent over the IP network; and sending the edited audio and/or video package over the IP network in accordance with the indicated priority.

In this case, the method may further comprise generating the edited audio and/or video package using the edit decision list before sending the generated edited audio and/or video package over the IP network.

According to another aspect, there is provided an apparatus for prioritising content for distribution from a camera to a server over an Internet Protocol (IP) network, the apparatus comprising: a storage medium operable to store a plurality of audio and/or video data packages to be distributed to the server over the IP network; an input interface operable to obtain information indicating the priority at which each audio and/or video package is to be distributed over the IP network, the priority being determined in accordance with the content of the audio and/or video package; and a transmission device operable to send each audio and/or video data package over the IP network, the order in which each audio and/or video data package is sent being determined in accordance with the indicated priority.

The apparatus may comprise: a metadata generator operable to generate metadata associated with the content of each of the audio and/or video data packages, and wherein the transmission device is further operable to send the generated metadata over the IP network to the server, wherein the priority information is generated at the server in accordance with the metadata and is obtained over the IP network.

The metadata may comprise a low resolution version of the audio and/or video data package.

The priority information may be provided by the server in response to a poll from the camera.

The apparatus may further comprise an input device operable to obtain an edit decision list defining an edited audio and/or video package to be generated from the stored plurality of audio and/or video packages, the input device being further operable to obtain information indicating the priority at which the edited audio and/or video package is to be sent over the IP network; and the transmission device is operable to send the edited audio and/or video package over the IP network in accordance with the indicated priority.

The apparatus may comprise an editing device operable to generate the edited audio and/or video package using the edit decision list before sending the generated edited audio and/or video package over the IP network.

According to a further aspect, there is provided a system for distributing audio and/or video data comprising a camera operable to capture content, the capture device, in use, being connected to an apparatus according to any of the above embodiments.

The system may further comprise an IP network connecting the apparatus to an editing suite.

The IP network may be a cellular network.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a system according to embodiments of the present invention;

FIG. 2 shows a file system used in memory within the camera of the system of FIG. 1;

FIG. 3 shows an editing suite within the studio of the system of FIG. 1;

FIG. 4 shows prioritisation instructions for use by the camera shown in FIG. 1 according to one embodiment;

FIG. 5 shows a flow diagram explaining the operation of the system according to FIG. 1; and

FIG. 6 shows prioritisation instructions for use by the camera shown in FIG. 1 according to a second embodiment.

### DESCRIPTION OF THE EMBODIMENTS

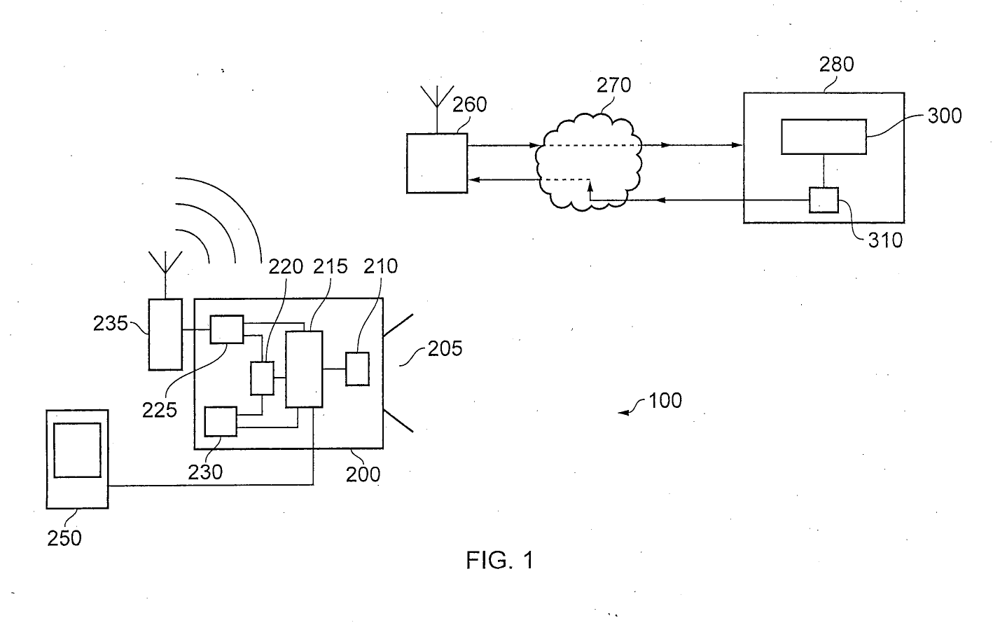

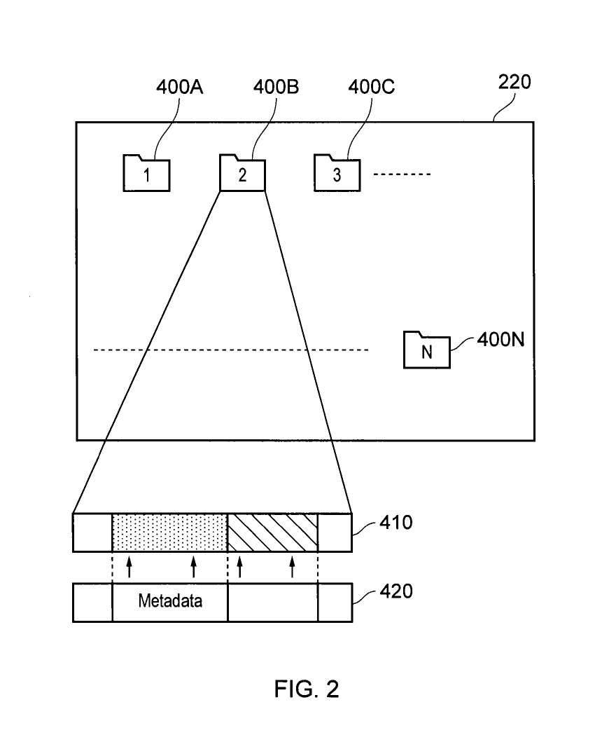

Referring to FIG. 1, a system 100 according to embodiments of the present invention is shown. In this system 100, a camera 200 is shown. This camera 200 has a lens 205 and body to capture images of a scene. Specifically, the images pass through the lens 205 and arrive at an image capturing device 210 located behind the lens 205. The image capturing device 210 may be a Charge Coupled Device (CCD) or a Complementary Metal Oxide Semiconductor (CMOS) sensor. This converts the light imparted onto the image capturing device 210 into an electrical signal which may be stored. Once captured, the images are stored on a memory 220. Additionally stored within the memory is audio captured from the scene using a microphone (not shown) and any metadata, which will be explained later. The memory 220 may be a solid state memory or may be an optically or magnetically readable memory. The memory 220 may be fixedly mounted within the camera body or may be removable, such as a MemoryStick(R) or the like. The manner in which the captured images are stored within the memory 220 will be described with reference to FIG. 2.

It should be noted here that in this case, although only one camera is shown, it is envisaged that any camera operator may have a plurality of cameras in one location. It is therefore envisaged that although the description only relates to a single camera this is only for clarity of explanation and the system may in reality have a plurality of cameras in any one location.

Returning to FIG. 1, a controller 215 within the camera 200 is connected to both the image capturing device 210 and the memory 220. Within the controller 215 an identification number is stored. This identification number uniquely identifies the camera 200 and, in embodiments is a Media Access Control (MAC) address. Additionally, the controller 215 is connected to a wireless transceiver 225 and a video editor 230. Although the camera 200 has a basic user interface located on the casing (allowing the user to control basic camera functions such as zoom, record, playback and the like), further functionality can be provided by connecting a portable device 250 to the camera 200. The portable device 250 may be a personal digital assistant (PDA), or may be a smartphone such as the Sony Ericsson Xperia or a tablet device such as the Sony Tablet S. Although shown as wired to the camera 200, the portable device 250 may be wirelessly connected to the camera 200 using Bluetooth or WiFi or the like. The portable device 250 allows the camera operator to include further information about a captured scene such as relevant metadata like the title of a clip, or good shot markers, or semantic metadata describing the content of the scene which has been captured or the like. As will be explained later, the portable device 250 allows the camera operator to also attribute priority information to the clip shot by the camera if necessary. The priority information allows the camera operator to define whether he or she feels that the clip is important and needs to be distributed over the network as soon as possible. This camera operator defined priority information may be used by an editor located in a location remote to the camera (such as a studio) to determine the overall priority of the clip as will be explained later. For example, a clip of high priority may be crucial to a breaking news event and so needs broadcasting immediately. This priority information may be a Boolean flag indicating that a clip is important or not important.

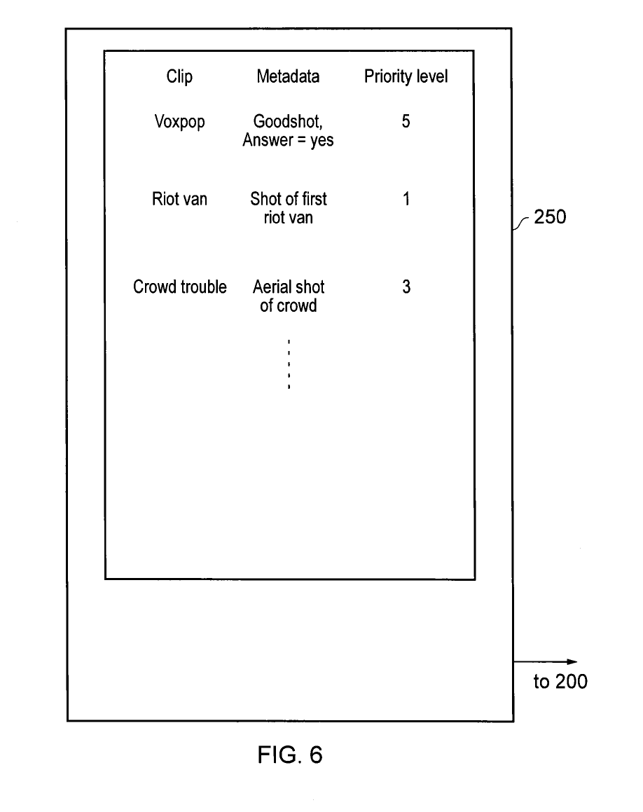

Additionally, and according to the second embodiment, the priority information may be more specific identifying how important a clip is compared with the other clips stored in the memory 220. This is shown in more detail in FIG. 6.

The memory 220 is also connected to both the video editor 230 and the wireless transceiver 225. The wireless transceiver 225 is connected to a 3G/4G interface 235.

The 3G/4G interface 235 is configured to transmit and receive data over a cellular network. In FIG. 1, the 3G/4G interface 235 communicates with a cellular network 260.

In addition or as an alternative to the 3G/4G dongle 235, the camera may include a WiFi transceiver (not shown) which would enable large quantities of data to be transmitted thereover. Although the description noted that data is transferred over a cellular network, the invention is not so limited. Indeed, instead of being transferred over the cellular network, the data may be transferred wholly over the WiFi network. Further, WiFi may be used in combination with the cellular network so that some data is sent over the WiFi network and some data is sent over the cellular network. Whether WiFi is used to assist or instead of the cellular network, or is indeed not used at all (i.e. the data is transferred wholly over the cellular network) is envisaged and would be appreciated by the skilled person. However, it is noted that WiFi is another example of an IP network.

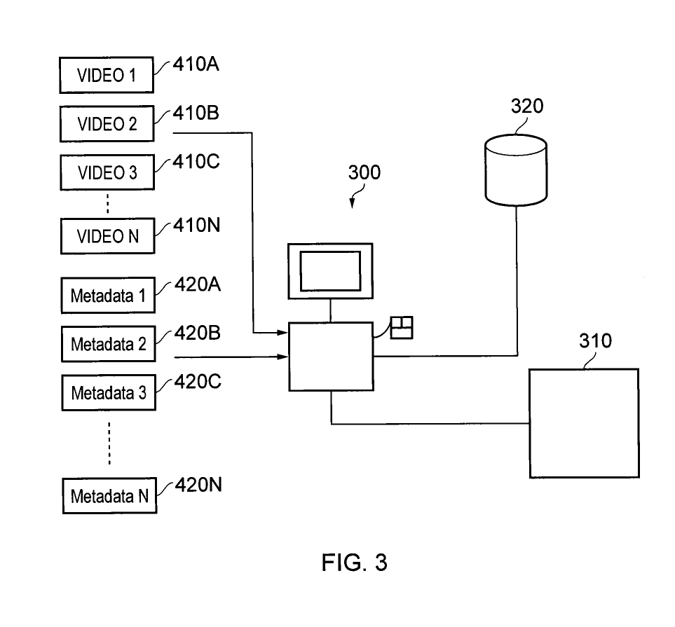

The cellular network 260 is connected to the Internet 270. As the skilled person appreciates, the cellular network 260 enables two-way data to be transmitted between the camera and a studio 280. In embodiments of the present invention, this network is configured to act as an Internet Protocol (IP) based network which interacts with the Internet 270. The studio 280 has an editing suite 300 and a prioritisation server 310 located therein. As will be explained later, the prioritisation server 310 stores information that indicates the priority at which audio and/or video content stored within the camera 200 should be uploaded to the studio 280. It should be noted here that the prioritisation server 310 may also store the uploaded content. However, it is envisaged that a separate server (not shown in this Figure, but is content server 320 in FIG. 3) within the studio 280 may store the uploaded content.

Referring to FIG. 2, a diagram explaining the mechanism by which the audio and/or video data is stored in the memory 220 is shown. Every time the camera 200 records a “take” of audio and/or video data, a new file 400A is created in the memory 220. In embodiments, a “take” is a predetermined scene of audio and/or video. This may be one or more clips. As can be seen from FIG. 2, typically, a number of files 400A to 400N (and thus “takes”) are stored within the memory 220. In the embodiment of FIG. 2, the file 2 contains two clips of audio and/or video data 410. In FIG. 2, each clip is shown as a dotted background and a hashed line background. In embodiments, the audio and/or video data 410 is of broadcast quality. In other words, the audio and/or video data 410 requires a data rate of 25 Mb/s to 50 Mb/s to be streamed live.

Associated with each clip is metadata 420. The metadata may be created by the camera operator and may describe the content of the file and/or each clip within the file. This may include pertinent keywords allowing content to be easily searched which may be for example “voxpop of person agreeing with question” or “Queen talking to crowd”. This is sometimes called semantic metadata. Additionally, the metadata 420 may include syntactic metadata which describes the camera parameters such as zoom and focus length of the lens, and other information such as a good shot marker and the like.

Additionally, or alternatively, in embodiments, the metadata is a low resolution version of the captured and stored audio and/or video data 410. The low resolution version may be a down sampled version of the broadcast quality audio and/or video data. The down sampled version may be representative key stamps, or may simply be a thumbnail sized streamed version of the broadcast quality footage. This low resolution version of the content may be generated after completion of the file or may be created “on the fly” as the content is being captured.

It is important to note two features of the low resolution version of the broadcast quality audio and/or video footage however. Firstly, the low resolution version is smaller in size than the broadcast quality footage and thus requires a much lower data rate to stream the low resolution version. Secondly, the low resolution version must enable a user, when viewing the low resolution version, to determine the content of the broadcast quality footage to which it relates.

In embodiments, the low resolution version of the broadcast quality footage has a data rate of around 500 kb/s. As the skilled person will appreciate, this data rate would enable the low resolution footage to be streamed in real-time over a 3G/4G network, even if the 3G/4G network is busy. It should be also noted, that a data rate of 500 kb/s allows the low resolution version of the content to be viewed and understood by a viewer, but would not have sufficient clarity to be classed as broadcast quality. Further, although 500 kb/s is provided as an example data rate, the invention is not so limited and the amount of compression and down-sampling applied to create the low resolution version may vary depending upon network resource allocated to the camera 200. So, where network capacity is high (i.e. higher data rates than 500 kb/s can be tolerated), the amount of compression and down-sampling applied to the broadcast quality audio and/or video data may be less than where network capacity is low. In embodiments of the invention, the amount of data capacity over the network is provided by the 3G/4G interface 235 to the controller 215 and the controller 215 controls the compression and down-sampling accordingly.

The metadata 420 also includes address information such as Unique Material Identifiers (UMIDs) or Material Unique Reference Numbers (MURNs) which identifies the location of the broadcast quality footage within the storage medium 220. In other words, by knowing the address information it is possible to locate the broadcast quality footage within the storage medium 220. It is also envisaged that the metadata 420 may also include an asset code complying with the Entertainment Identifier Registry (EIDR) which identifies the location of the broadcast quality footage within the storage medium 220.

The metadata 420 which includes the description of the content of the file and the address information is then streamed over the cellular network 260 as IP compliant data. This metadata 420 is fed to the studio 280 via the Internet 270.

It should be noted here that some broadcast quality audio and/or video data 410 is also sent over the cellular network 260 as IP compliant data using the network resource unused by the streaming of the metadata 420. In other words, the metadata 420 is sent over the cellular network 260 and any spare capacity is used to send broadcast quality audio and/or video material. This ensures that the network capacity is used most efficiently. By sending the metadata and broadcast quality audio and/or video as IP compliant data means that the camera can be located anywhere in the world relative to the studio as the data can be transmitted over the Internet 270.

The broadcast quality audio and/or video material sent over the cellular network 260 may or may not be related to the metadata that is currently being sent over the network. In other words, at any one time, the metadata being sent may or may not be related to the broadcast quality audio and/or video. In fact, as will be explained later, the order in which the broadcast quality audio and/or video is sent over the cellular network 260 is instead dependent upon the priority allocated to the broadcast quality footage. Therefore, high priority broadcast quality audio and/or video footage is sent before lower priority broadcast quality footage.

A first embodiment explaining how the priority level is determined will be described with reference to FIG. 3. The editing suite 300 located within the studio 280 receives the metadata 420A-420N over the cellular network 260 and the Internet 270. As noted above, the broadcast quality audio and/or video 410A-410N is also received by the editing suite 300. This broadcast quality footage is then stored in the content server 320. It should be noted here that although the foregoing uses the term “editing suite”, the skilled person would appreciate that some broadcasters have dedicated facilities to receive incoming audio and/or video feeds. These are sometimes referred to as “lines recording” or “ingest” facilities. As embodiments of the invention do not relate to the received broadcast quality content, the use of the received content will not be explained further.

The editing suite 300 which receives the metadata 420A-420N is controlled by an operator. The operator reviews the metadata 420A-420N as it is received. While it is possible for the operator to review all metadata received over the cellular network 260, it may be very difficult to review high numbers of metadata streams. Therefore, in embodiments, the operator will only review metadata from files that the camera operator has indicated as being important. The indication whether the metadata is important is given by a flag or some other indication located within the metadata itself. As the camera operator identifies important metadata, the operator within the editing suite 300 will be able to quickly review important metadata. This will reduce the burden on the operator of the editing suite 300.

It should be also noted here that in reality, the operator within the editing suite 300 will receive metadata and broadcast quality audio and/or video from many locations. In other words, the system according to one embodiment of the present invention includes a plurality of cameras such cameras being provided over one or more locations.

Additionally, if there is a breaking news story, the operator in the editing suite 300 may review all the metadata generated by the camera operators located in the proximity of the breaking news event. This again provides an intelligent mechanism to reduce the burden on the editing suite operator without risking missing a piece of important audio and/or video footage. The proximity may be determined using geographical positioning information such as GPS information which may be sent as part of the metadata 420A-420N and identifies the location of the camera 200.

After the operator in the editing suite 300 has reviewed the metadata (420A-420N) received over the cellular network 260, the operator of the editing suite can decide the priority level that should be attributed to the broadcast quality footage described by the metadata.

This priority may be on a file level. So, in this case, if footage (stored in one file within the camera) of for example a riot is sent from a breaking news event, the operator of the editing suite may consider the file having this footage of the riot as having a higher priority than a file containing “vox-pop” footage (stored as a different file within the same camera) from a different location. Therefore, the file of the riot will be uploaded to the editing suite before the file of the “vox-pop”.

However, if only a small segment of footage contained in the file of the riot is to be included in the broadcast program, then the network resource could be used more efficiently if only the relevant footage contained in the file is to be uploaded. This is particularly the case where two different files within the camera are deemed to have equally high priority.

The operator of the editing suite 300 can also set the priority based on a footage level. That is, the operator of the editing suite 300 can define a priority to a segment (which is smaller than the whole file) of footage within a file which is to be uploaded. This segment is defined by the address information contained within the metadata. By enabling the operator to set the priority level based on a footage level, the operator may attribute different priorities to different segments of footage within the same file. By setting the priority on the footage level, the network resource is used more efficiently because only the relevant section of the file is uploaded at a high priority.

In the case of a multi-camera system (i.e. where a plurality of cameras communicate with the editing suite 300), footage captured from one camera my given a higher priority than footage captured from a different camera. This may be a result of one camera being in a better location than a second camera, or may be because one camera captures higher resolution footage. Also, as the breaking news event evolves, footage from one camera may become more relevant than footage captured by another camera and so the priority levels of cameras relative to one another may change.

Prior to setting the priority level, the operator of the editing suite 300 may perform a rough edit of different segments of footage either from the same or different files.

For example, using the example above, if the “vox-pop” footage in one file is an interview with a rioter, the “vox-pop” footage located in one file may be as important as the footage of the riot from another file.

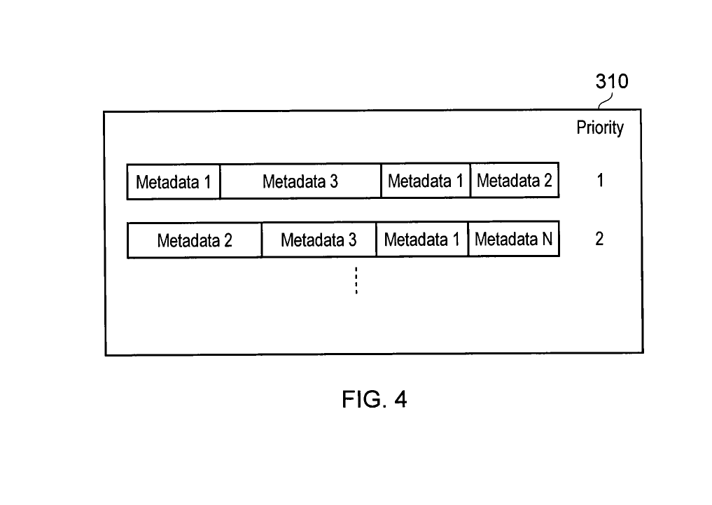

In this case, and as shown in FIG. 4, segments of metadata may be edited together by the operator of the editing suite 300. The edited metadata is stored on the prioritisation server 310. The edited footage (which includes the relevant sections from the file of the riot footage and the relevant sections from the file of the vox-pop) itself can be attributed as having a particular priority level. This has two distinct advantages. Firstly, only the relevant footage from the file of the riot and the relevant footage from the file of the vox-pop will be uploaded to the studio 280. This more efficiently uses network resource. Secondly, the footage uploaded to the studio 280 will be in a roughly edited form which enables the footage to be broadcast more quickly. This second advantage is particularly useful where the edited footage is high priority.

A brief summary of the metadata provided on the prioritisation server 310 will now be given. The prioritisation metadata comprises a camera identifier, an address identifier indicating the address of the broadcast quality audio and/or video footage and optionally any editing effects to be applied and a priority level associated with the broadcast quality audio and/or video footage.

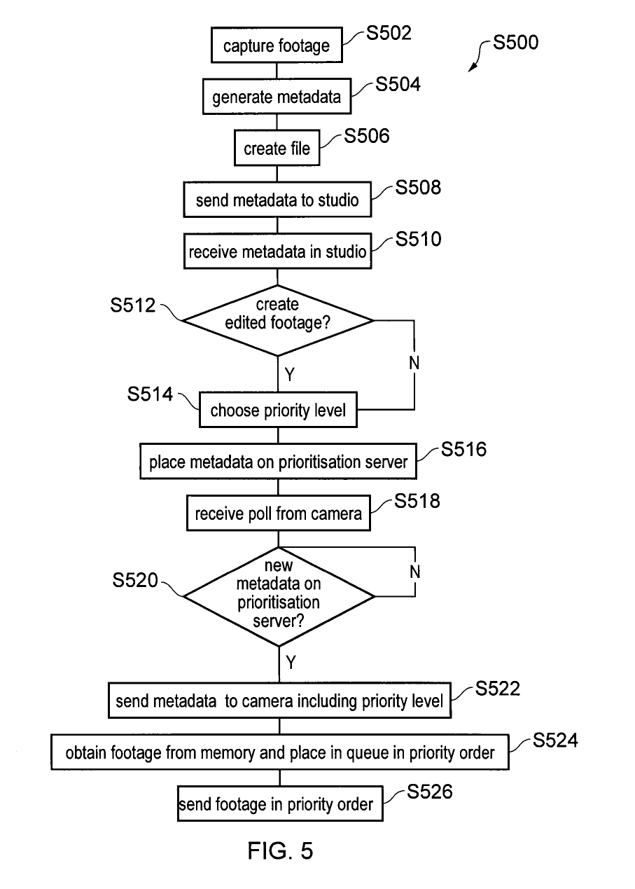

The operation of the system will now be described with reference to the flow chart s500 of FIG. 5. The camera 200 captures footage in step s502. Metadata which includes the address identifier and an indication of the content of the footage is generated in step s504.

This metadata may be created “on the fly” (i.e. when the content is being captured) or after the scene has been shot. Also provided in the metadata is the identification address of the camera 200. The footage and the metadata are placed into a newly created file when the operator has finished shooting the footage (s506).

The metadata which includes the address of the broadcast quality footage within the file, the indication of the content of the footage and the camera identifier (MAC address, for example) is sent over the cellular network 260 in step s508. The metadata is received in the studio in step s510.

From the indication of the content of the footage, the operator of the editing suite 300 determines whether edited footage is to be created. If so, a rough edit of the footage is created using the received metadata.

A priority level is chosen by the operator of the editing suite 300 to determine the priority at which the camera 200 is to upload the footage. In this case, the footage may be the entire file, part of a file or a rough edit composed of one or more segments from one or more files. This is carried out in step s514. As an alternative, the camera may automatically prioritise the upload. For example, if the footage is a rough edit, the camera may automatically assign this to have the highest priority.

Prioritisation metadata indicating the footage to be retrieved from the camera 200 and an associated priority level associated with that footage is placed on the prioritisation server 310.

More specifically, the metadata on the prioritisation server 310 includes the identification address of the camera 200, the address indicator of the broadcast quality footage stored within the memory 220 and the priority level associated with the footage. This is carried out in step s516.

The camera 200 polls the prioritisation server 310 to determine whether new prioritisation metadata for the camera 200 has been placed on the prioritisation server 310. This occurs in step S518. If no new prioritisation metadata is placed on the prioritisation server 310, the prioritisation server 310 waits for the poll from the next camera. If however, new metadata is placed on the prioritisation server 310 for the camera 200, the metadata stored on the prioritisation server 310 is sent to the camera 200. This is carried out in step s522.

The camera 200 after receiving the metadata obtains the broadcast quality audio and/or video stored within memory 220. This may include forming the roughly edited clip if appropriate. The roughly edited clip is formed in the video editor 230 located in the camera 200. The broadcast quality footage or roughly edited clip is placed in a queue of other broadcast quality audio/video from the camera 200 to be sent over the cellular network 260. It should be noted that the broadcast quality footage or clip is placed in the order of priority within the queue so that footage and/or clips having a high priority are sent first over the cellular network 260. This is carried out in step s524.

Finally, the broadcast quality footage is sent over the cellular network 260 in priority order (step s526).

FIG. 6 shows an embodiment in which the camera operator provides a priority level for the footage captured by the camera 200. Specifically, in the embodiment of FIG. 6, it is possible for the camera operator to allocate specific priority levels to all the different footage stored within the memory 220. This priority information can be used to determine the order in which the broadcast quality audio and/or video is sent to the studio. In other words, the camera operator is capable of prioritising the order in which the broadcast quality audio and/or video is sent to the studio.

Additionally, or alternatively, this priority information can be sent to the studio with the metadata as explained previously. In this case, the priority information provided by the camera operator can be used by the operator of the editing suite 300 in determining the priority levels of the footage or the rough edits and their associated priorities.

Although the foregoing has been explained with reference to a separate camera 200 and user device 150, the invention is not limited. Specifically, it is possible that the camera 200 could be integrated into a smartphone and that the smartphone operator can prioritise the transmission of the footage over a cellular network. In this case, it is unlikely that the operator of the editing suite 300 will be able to see all the footage received from all the smartphones providing content. However, if the smartphone is provided with position information, such as GPS information, uniquely identifying the geographical location of the user, and if this information is sent along with the metadata of the captured content, the operator of the editing suite 300 may be able to see only footage submitted by users who captured content at a particular geographical location at a particular time. This is particularly useful with a breaking news event, which relate to a particular location at a particular time.

In order to configure the smartphone to operate in this manner, a smartphone application will need to be downloaded from a particular website or portal such as the Android Market.

Although the foregoing also mentions the apparatus being integrated into a camera device (either as a standalone device or a smartphone form-factor), the invention is not so limited. Indeed the apparatus may be a device separate to a camera and receive an image feed from a camera.

Although the foregoing describes the image data and/or metadata being transferred over a cellular network, any kind of IP based network is equally applicable. For example, the data may be transferred over WiFi or a home network or the like.

Although the foregoing has mentioned an operator of the editing suite 300, this process may be automated such that the priority of the footage selected by the camera operator and other information such as location information of the camera and time of capture of the footage may be used to determine the priority attributed by an automated editing suite.

Embodiments of the present invention are envisaged to be carried out by a computer running a computer program. The computer program will contain computer readable instructions which, when run on the computer, configure the computer to operate according to the aforesaid embodiments. This computer program will be stored on a computer readable medium such as a magnetically readable medium or an optically readable medium or indeed a solid state memory. The computer program may be transmitted as a signal on or over a network or via the Internet or the like.

Obviously, numerous modifications and variations of the present disclosure are possible in light of the above teachings. It is therefore to be understood that within the scope of the appended claims, the invention may be practiced otherwise than as specifically described herein.

1. A method of prioritising content for distribution from a camera to a server over an Internet Protocol (IP) network, the method comprising: storing a plurality of audio and/or video data packages to be distributed to the server over the IP network; obtaining information indicating the priority at which each audio and/or video package is to be distributed over the IP network, the priority being determined in accordance with the content of the audio and/or video package; sending each audio and/or video data package over the IP network, the order in which each audio and/or video data package is sent being determined in accordance with the indicated priority; generating metadata associated with the content of each of the audio and/or video data packages, and sending the generated metadata over the IP network to the server, wherein the priority information is generated at the server in accordance with the metadata and is obtained over the IP network.

2. A method according to claim 1, wherein metadata comprises a low resolution version of the audio and/or video data package.

3. A method according to claim 2, wherein the priority information is provided by the server in response to a poll from the camera.

4. A method according to claim 1 further comprising obtaining an edit decision list defining an edited audio and/or video package to be generated from the stored plurality of audio and/or video packages, obtaining information indicating the priority at which the edited audio and/or video package is to be sent over the IP network; and sending the edited audio and/or video package over the IP network in accordance with the indicated priority.

5. A method according to claim 4, comprising generating the edited audio and/or video package using the edit decision list before sending the generated edited audio and/or video package over the IP network.

6. A computer program comprising computer readable instructions which, when loaded onto a computer, configure the computer to perform a method according to claim 1.

7. A computer program product configured to store the computer program of claim 6 therein or thereon.

8. An apparatus for prioritising content for distribution from a camera to a server over an Internet Protocol (IP) network, the apparatus comprising: a storage medium operable to store a plurality of audio and/or video data packages to be distributed to the server over the IP network; an input interface operable to obtain information indicating the priority at which each audio and/or video package is to be distributed over the IP network, the priority being determined in accordance with the content of the audio and/or video package; a transmission device operable to send each audio and/or video data package over the IP network, the order in which each audio and/or video data package is sent being determined in accordance with the indicated priority; a metadata generator operable to generate metadata associated with the content of each of the audio and/or video data packages, and wherein the transmission device is further operable to send the generated metadata over the IP network to the server, wherein the priority information is generated at the server in accordance with the metadata and is obtained over the IP network.

9. An apparatus according to claim 8, wherein metadata comprises a low resolution version of the audio and/or video data package.

10. An apparatus according to claim 8, wherein the priority information is provided by the server in response to a poll from the camera.

11. An apparatus according to claim 8 further comprising an input device operable to obtain an edit decision list defining an edited audio and/or video package to be generated from the stored plurality of audio and/or video packages, the input device being further operable to obtain information indicating the priority at which the edited audio and/or video package is to be sent over the IP network; and the transmission device is operable to send the edited audio and/or video package over the IP network in accordance with the indicated priority.

12. An apparatus according to claim 11, comprising an editing device operable to generate the edited audio and/or video package using the edit decision list before sending the generated edited audio and/or video package over the IP network.

13. A system for distributing audio and/or video data comprising a camera operable to capture content, the capture device, in use, being connected to an apparatus according to claim 8.

14. A system according to claim 13, further comprising an IP network connecting the apparatus to an editing suite.

15. A system according to claim 13, wherein the IP network is a cellular network.
